(19) United States
(12) Patent Application Publication
(10) Pub. No.: US 2002/0174193 A1
(43) Pub. Date: Nov. 21, 2002

(54) Split client-server software development architecture

(76) Inventor: Andrei Sergeevich Mikhalchuk, Moscow (RU)

Correspondence Address: DANIEL J SWIRSKY, PO BOX 2345, BEIT SHEMESH, 99544, IL

(21) Appl. No.: 09/843,935

(22) Filed: Apr. 30, 2001

(51) Int. Cl. G06F 15/16

(52) U.S. Cl. 709/219

(57) ABSTRACT

A split client-server software development architecture including a client, at least one software module resident on the client, a network, a server, and a core application resident on the server, where the client is operative to upload the at least one software module to the server via the network, and the server is operative to couple the core application and the at least one software module and instate an application instance formed therefrom.

### FIELD OF THE INVENTION

The present invention relates to software development in general, and more particularly to software development that is split between client and server computers.

### BACKGROUND OF THE INVENTION

While some makers of software development tools have embraced the so-called “open source” model of software development, where software source code is made available to software developers, others, particularly commercial software development tool makers, have long sought to protect their software by providing libraries of compiled software modules or executable software modules to software developers. Those who desire to keep their source code a secret often depend on legal means such as requiring software developers to enter into contractual agreements with the author whereby the software developer agrees not to reverse engineer the provided compiled or executable software in order to discover the underlying programming code or logic. Unfortunately, such agreements do not always deter developers from reverse engineering software, potentially compromising the commercial viability of such software.

### SUMMARY OF THE INVENTION

The present invention seeks to provide a software development architecture that allows the authors of software used for farther software development to provide software developers with access to their software in order to create and test applications while physically preventing developers from disassembling or reverse engineering the software in order to discover the underlying programming code or logic.

There is thus provided in accordance with a preferred embodiment of the present invention a split client-server software development architecture including a client, at least one software module resident on the client, a network, a serve, and a core application resident on the server, where the client is operative to upload the at least one software module to the server via the network, and the server is operative to couple the core application and the at least one software module and instantiate an application instance formed therefrom.

Further in accordance with a preferred embodiment of the present invention the software module is in either of a source code and an object code format.

Still further in accordance with a preferred embodiment of the present invention the software module includes at least one application program interface (API) call to a procedure included in the core application.

Additionally in accordance with a preferred embodiment of the present invention the core application includes at least one application programming interface (API) call to a procedure included in the software module.

Moreover in accordance with a preferred embodiment of the present invention the client is operative to upload the at least one software module to the server via the network the File Transfer Protocol (FTP).

Further in accordance with a preferred embodiment of the present invention the client is operative to upload at least one configuration parameter to the server identifying the core application.

Still further in accordance with a preferred embodiment of the present invention the client is operative to upload at least one configuration parameter to the server identifying at least one supporting module resident on the server and the server is operative to couple the core application, the at least one software module, and the at least one supporting module and instantiate an application ice formed therefrom.

Additionally in accordance with a preferred embodiment of the present invention the client is operative to provide input to the application instance via the network.

Moreover in accordance with a preferred embodiment of the present invention the application instance is operative to provide output to the client via the network.

Further in accordance with a preferred embodiment of the present invention the client includes development apparatus for interfacing with a user and receiving the at least one software module therefrom.

Still further in accordance with a preferred embodiment of the present invention the development apparatus is operative to upload the at least one software module to the server.

Additionally in accordance with a preferred embodiment of the present invention the development apparatus is operative to upload at least one configuration parameter to the server.

Moreover in accordance with a preferred embodiment of the present invention the server is operative to couple the at least one software module with a previously instantiated application instance.

There is also provided in accordance with a preferred embodiment of the present invention a split client-server software development architecture including a client, a network, a server, a core application resident on the server, and at least one software module resident on the server, where the server is operative to couple the core application and the at least one software module and instantiate an application instance formed therefrom, and the client is operative to control the application instance by sending at least one command to the server via the network.

There is additionally provided in accordance with a preferred embodiment of the present invention a spit client-server software development method including the steps of developing at least one plug-in module at a client for interfacing with a core application on a server, uploading the plug-in nodule to the server, communicating to the server an identifier identifying the core application to be used with the plug-in module, creating an application instance on the server including the core application and the plug-in module, and executing the application on the server.

Further in accordance with a preferred embodiment of the present invention the developing step includes developing the at least one plug-in module to interface with at least one supporting module on the server, the communicating step includes communicating to the server an identifier identifying the at least one supporting module to be used with the plug-in module, and the creating includes creating an application instance on the server including the core application, the plug-in module, and the supporting module.

Still further in accordance with a preferred embodiment of the present invention the creating step includes creating a plural of instances of the application on the server.

### BRIEF DESCRIPTION OF THE DRAWINGS

The present invention will be understood and appreciated more fully from the following detailed description taken in conjunction with the appended drawings in which:

FIG. 1 is a simplified pictorial illustration of a split client-server software development architecture, constructed and operative in accordance with a preferred embodiment of the present invention;

FIG. 2 is a simplified block diagram of an exemplary functional implementation of the architecture of FIG. 1, constructed and operative in accordance with a preferred embodiment of the present invention; and

FIG. 3 is a simplified flowchart illustration of a method of operation of the system of FIGS. 1 and 2, operative in accordance with a preferred embodiment of the present invention.

### DETAILED DESCRIPTION OF PREFERRED EMBODIMENTS

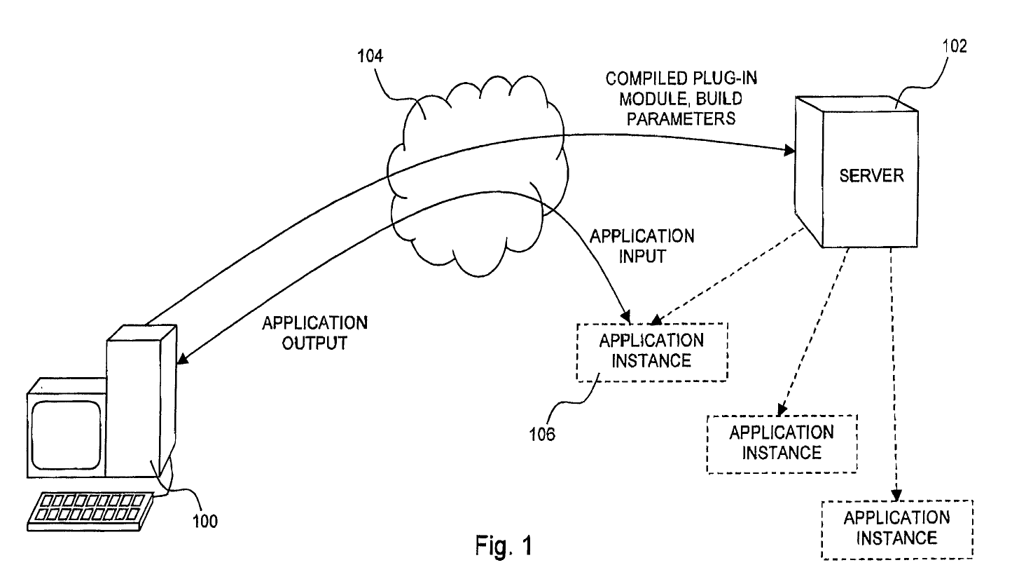

Reference is now made to FIG. 1, which is a simplified pictorial illustration of a split client-server software development architecture, constructed and operative in accordance with a preferred embodiment of the present invention. In the architecture of FIG. 1 a client 100 is used for developing a software module that is uploaded to a server 102 as source code, object code, or other code state via a network 104, such as the Internet. The software module is preferably configured as a plug-in module for use with a core application that resides on server 102 and whose plug-in requirements are known. The core application and the plug-in module may use any known method to communicate with each other and invoke processes therein. For example, the plug-in module developed at client 100 may include application programming interface (API) calls to procedures included in the core application on server 102. Likewise, the core application may make calls to the plug-in module. Additionally or alternatively to API calls, the plug-in module and core application may communicate via sockets. Client 100 may perform uploading to server 102 using any conventional technique, such as by using the File Transfer Protocol (FTP) or by using dedicated client software with upload capabilities, such as is described hereinbelow. Client 100 also preferably uploads configuration parameters to server 102 indicating which core application and supporting modules should be used, preferably in conjunction with developer and/or project identification information. Server 102 then combines the plug-in module with the core application and any required support modules, such as indicated by the configuration parameters, to create an instance 106 of the combined application. The application instance 106 is then executed by server 102. Input to application instance 106 may be sent from client 100, and any output by application instance 106 may then be sent to client 100 via network 104 and displayed using conventional techniques.

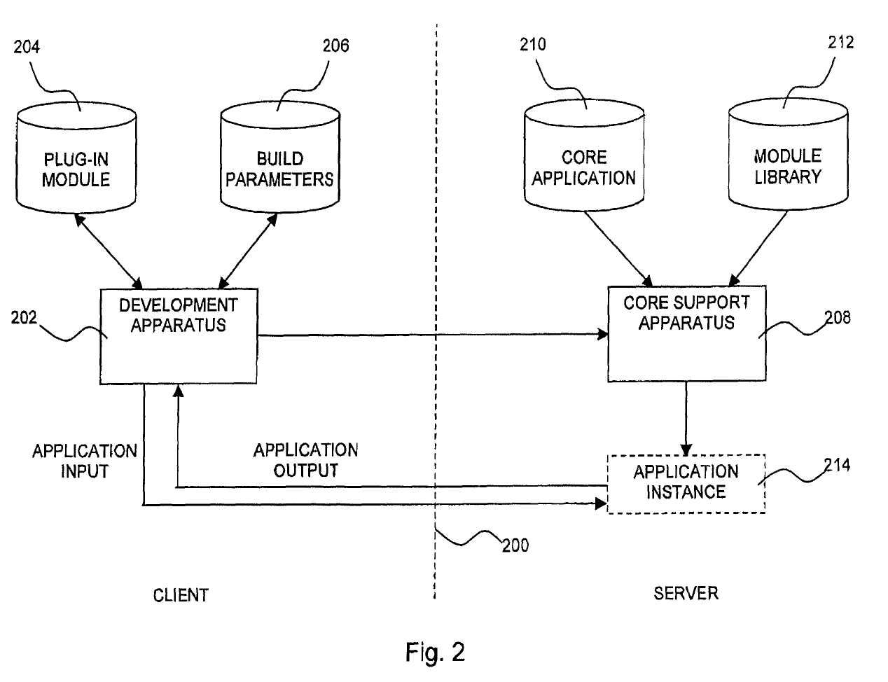

Reference is now made to FIG. 2, which is a simplified block diagram of an exemplary functional implementation of the architecture of FIG. 1, constructed and operative in accordance with a preferred embodiment of the present invention Shown in FIG. 2 are client-side and server-side functional responsibilities on either side of a dashed line 200. On the client side, development apparatus 202 is preferably provided for interfacing with a user who provides to development apparatus 202 one or more plug-in modules 204 and configuration parameters 206. Development apparatus 202 then uploads the plug-in modules 204 and configuration parameters 206 to core support apparatus 208 on the server side. Configuration parameters 206 may be uploaded at any time, together with the plug-in modules 204 or otherwise. Furthermore, the configuration parameters 206 may be uploaded only once and stored at core support apparatus 208 and reused each tin new plug-hi modules 204 are uploaded. Core support apparatus 208 retrieves the appropriate core application 210, such as indicated by the configuration parameters, and any other support modules 212 required by the core application 210 or otherwise indicated by the configuration parameters. Core support apparatus 208 then combines the plug-in module received from the client side with the core application and other modules and creates an application instance 214 which the server side then executes. The application instance 214 then receives input from and/or provides output to the client side, such as via development apparatus 202. If an application instance 214 already exists, such as where a previous version of the plug-in modules 204 have already been uploaded, the configuration parameters 206 may indicate whether the instance is to be terminated and a new instance created, or whether new versions of the plug-in modules 204 may be used with the existing instance.

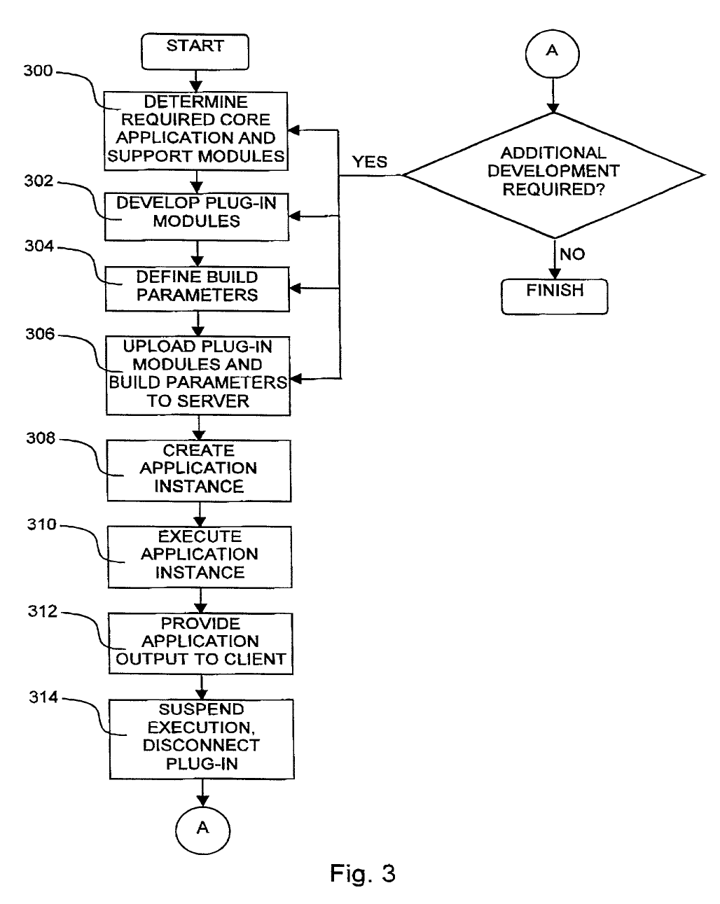

Reference is now made to FIG. 3, which is a simplified flowchart illustration of a method of operation of the system of FIGS. 1 and 2, operative in accordance with a preferred embodiment of the present invention. In the method of FIG. 3 a developer determines which core application and supporting modules he requires (step 300). The developer then develops one or more plug-in modules at the client that are designed to interface with the core application and any supporting modules (step 302). The developer then defines configuration parameters identifying the make-up of the resulting applications including the developer's plug-in modules, the core application, and any supporting modules (step 304). The plug-in modules and configuration parameters are then uploaded to the server, typically using development apparatus 202 (FIG. 2) (step 306). Once the plug-in modules and configuration parameters are received at the server, core support apparatus 208 creates an instance of the appropriate core application, or dedicates an existing instance, together with the plug-in modules and supporting modules (step 308). The server then executes the created application (step 310) and provides any output to the developer at the client (step 312). At any time, the developer may send a command to core support apparatus 208 to suspend execution and disconnect the plug-in from the core application (step 314). Other commands may also be sent, such as for changing debug levels, stopping and starting the core application, changing the configuration parameters, redirecting output and input, managing and reordering plug-ins on the core application, and the state of core bus. These commands may be part of the configuration parameters sent before an application instance is created, or may be sent separately afterward. The developer may revise the plug-in module as needed and perform any of steps 300-314 one or more times as needed to complete the development cycle.

As seen in FIG. 1, server 102 may simultaneously maintain multiple instances of a single application, such as may be desirable for multi-user testing of an application, or single instances of multiple applications in support of different development efforts by different developers. Each plug-in uploaded as part of a given development effort may be maintained by server 102 in a version control system using conventional techniques over multiple development cycles to comprise a development history. Server 102 may also log development times so that core application usage may be rented.

The present invention may be adapted such that plug-in source code is stored on the server side, rather than being uploaded to the server as a compiled module. In this scenario the development apparatus 202 and core support apparatus 208 may both reside on server 102. This is particularly useful where multiple developers collaborate on a single project using a single application instance into which different plug-in modules may be incorporated. Alternatively, the plug-in modules may he stored on the server side as object code or other non-source-code format. Configuration parameters uploaded by one developer may identify modules developed by other developers for inclusion into a single application instance. For example, two developers may share a single core application instance and plug their modules into the instance asynchronously. A developer may leave his plug-in modules on the server side in order to allow others to include them in their own application configurations.

It is appreciated that one or more of the steps of any of the methods described herein may be omitted or carried out in a different order than that shown, without departing from the true spirit and scope of the invention.

It is appreciated that the methods and apparatus described herein may be implemented using computer hardware and/or software using conventional techniques.

The disclosures of all patents, patent applications, and other publications mentioned in this specification and of the patents, patent applications, and other publications cited therein are hereby incorporated by reference.

While the present invention has been described with reference to a few specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A split client-server software development architecture comprising:
a client;
at least one software module resident on said client;
a network;
a server; and
a core application resident on said server,
wherein said client is operative to upload said at least one software module to said server via said network, and
wherein said server is operative to couple said core application and said at least one software module and instantiate an application instance formed therefrom.

2. An architecture according to claim 1 wherein said software module is in either of a source code and an object code format.

3. An architecture according to claim 1 wherein said software module includes at least one application programming interface (API) call to a procedure included in said core application.

4. An architecture according to claim 1 wherein said core application includes at least one application program interface (API) call to a procedure included in said software module.

5. An architecture according to claim 1 wherein said client is operative to upload said at least one software module to said server via said network using the File Transfer Protocol (FTP).

6. An architecture according to claim 1 wherein said client is operative to upload at least one configuration parameter to said server identifying said core application.

7. An architecture according to claim 1 wherein said client is operative to upload at least one configuration parameter to said server identifying at least one supporting module resident on said server and wherein said server is operative to couple said core application said at least one software module, and said at least one supporting module and instantiate an application instance formed therefrom.

8. An architecture according to claim 1 wherein said client is operative to provide input to said application instance via said network.

9. An architecture according to claim 1 wherein said application instance is operative to provide output to said client via said network.

10. An architecture according to claim 1 wherein said client comprises development apparatus for interfacing with a user and receiving said at least one software module therefrom.

11. An architecture according to claim 10 wherein said development apparatus is operative to upload said at least one software module to said server.

12. An architecture according to claim 10 wherein said development apparatus is operative to upload at least one configuration parameter to said server.

13. An architecture according to claim 1 wherein said server is operative to couple said at least one software module with a previously instantiated application instance.

14. A split client-server software development architecture comprising:
a client;
a network;
a server;
a core application resident on said server; and
at least one software module resident on said server,
wherein said server is operative to couple said core application and said at least one software module and instantiate an application instance formed therefrom, and
wherein said client is operative to control said application instance by sending at least one command to said server via said network.

15. A split client-server software development method comprising the steps of:
developing at least one plug-in module at a client for interfacing with a core application on a server;
uploading said plug-in module to said server;
communicating to said server an identifier identifying said core application to be used with said plug-in module;
creating an application instance on said server comprising said core application and said plug-in module; and
executing stud application on said server.

16. A method according to claim 15 wherein:
said developing step comprises developing said at least one plug-in module to interface with at least one supporting module on said server,
said communicating step comprises communicating to said server an identifier identifying said at least one supporting module to be used with said plug-in module, and
said creating comprises creating an application instance on said server comprising said core application, said plug-in module, and said supporting module.

17. A method according to claim 15 wherein said creating step comprises creating a plurality of instances of said application on said server.
